(19) United States
(12) Patent Application Publication
(10) Pub. No.: US 2004/0215573 A1
(43) Pub. Date: Oct. 28, 2004

(54) Method and system for authorizing the use of merchant specific gift cards

(75) Inventors: Frederick William Teutenberg V, Des Peres, MO (US); Kennedy L. Hudson, St. Louis, MO (US)

Correspondence Address: K. Lee Marshall, BRYAN CAVE LLP, Suite 3600, 211 N. Broadway, St. Louis, MO, 63102-2750, US

(73) Assignee: Gift Cards LLC

(21) Appl. No.: 10/421,333

(22) Filed: Apr. 23, 2003

(51) Int. Cl. H04K 1/00

(52) U.S. Cl. 705/64

(57) ABSTRACT

A method and system for authorizing the use of merchant specific gift cards, which include a unique card number. When the numbers are entered into the merchant's financial transaction equipment, the authorization network automatically routes the authorization request to the card issuing institution. The card issuing institution verifies the validity of the gift card, that the merchant identification number corresponds to an authorized merchant at a specified location, and that sufficient funds exist in the gift card account. The card issuing institution then transmits the authorization or rejection back to the merchant through the financial transaction authorization equipment.

### FIELD OF THE INVENTION

The present invention relates generally to gift cards, and more particularly but not by way of limitation, to methods for limiting the use of gift cards to specific merchants or sites.

### BACKGROUND OF THE INVENTION

For decades, merchants seeking to offer their customers a form of store credit have offered gift certificates. A gift certificate is a paper instrument with merchant redeemable value. Gift certificates, however, tend to be cumbersome for purposes of accounting and record keeping. Another problem with gift certificates is the inability of merchants to benefit from the whole value of the certificate. That is, when a gift certificate is utilized to purchase items with a collective purchase price and applicable tax that is below the face value of the certificate, the remaining certificate value is typically returned to the recipient in the form of cash.

In recent years, gift cards have partially supplanted gift certificates as a merchant redeemable value instrument. Gift cards are typically sold in various fixed denominations, for example twenty dollars ($20), fifty dollars ($50), or one hundred dollars ($100) by a merchant or service provider to a customer. The recipient of the gift card may use the gift card as full or partial payment to purchase goods and services with the merchant.

In addition to easing the accounting and recordkeeping burdens associated with gift certificates, one especially attractive advantage of the card format lies in its ability to retain partial value. A traditional gift card utilizes a magnetic strip, typically on the backside of the card, which contains encoded information linked to the value of the card. The value of the gift card may thereby be reduced by a transaction amount, such that the merchant is assured of expenditures by the individual which match or exceed the original value of the gift card.

The validity and value of a gift card are typically maintained with a database maintained by the particular issuing merchant. A primary limitation of traditional gift cards is their inability to be utilized for making purchases with different non-related merchants. The gift card is limited to use with the merchant from which the card was purchased, because at the time of the purchase a cash transaction was performed by the card purchaser in exchange for the denomination of the gift card by the particular merchant.

Another significant limitation of gift cards is their inability to work with existing financial transaction authorization equipment. Merchants wishing to utilize gift cards typically must purchase additional or new equipment designed to process the amount of value on the card. These two limitations are interrelated in that the equipment used for gift cards, as well as the companies that service it, are typically not designed to communicate between non-related merchants.

These limitations are especially important in the context of destination shopping locations, such as shopping malls, in which the management of the location wishes to promote their location by selling redeemable value instruments, such as gift certificates and gift cards, which would be redeemable at all merchants at the location. Currently, such shopping locations are limited to selling gift certificates due to the inability of gift cards to be utilized at all merchants within their location. Alternatively, some shopping locations utilize debit cards, which are universally recognized and honored. But these debit cards necessarily can also be used at merchants outside of the shopping location, which prevents the shopping location from retaining the entire value of the debit card.

Thus, there remains a need for a gift card that can be utilized by a variety of non-related merchants, but at the same time can also be limited to specific designated merchants, such as those at a particular shopping mall.

### SUMMARY OF THE INVENTION

The invention described herein addresses these problems. The present invention discloses a method whereby a representative of a shopping location (such as a merchant, a shopping mall, a shopping district, etc.) is provided with a plurality of unactivated debit cards, each having a unique card number (the card ID information), which includes the ISO number of the card issuing institution. The unique card number may use the standard 16 digit numbering scheme or some alternative means for uniquely identifying each card. When a customer requests a gift card, the representative swipes one of the cards through the shopping mall card reader attached to a terminal and enters the gift card amount. This card reader contains a shopping location identification information, which serves to uniquely identify the shopping mall. The unique card number, the shopping location identification information, and the gift card amount are transmitted to and stored on a central database maintained by the card issuing institution. Each shopping location identification is associated with a list of authorized merchants identified by a unique identification number associated with the merchant's financial authorization equipment, referred to as a terminal ID information. As a result, each unique card number is authorized for use at a specified list of authorized merchants. The gift card is then activated at this point with the gift card amount.

Upon presentation of the gift card to a merchant, the merchant inputs the amount of the prospective purchase in its financial transaction authorization equipment. The merchant may use standard, existing financial transaction authorization equipment, such as standard MasterCard/Visa credit/debit card authorization equipment, but it should be understood that the use of such standard equipment is not a requirement of the invention. The authorization network recognizes the ISO number of the card issuing institution and automatically routes the authorization request, including the unique card number, that terminal ID information associated with the merchant, and the purchase amount, to said institution.

The card issuing institution transmits the authorization request to its central database to determine the following: (1) whether the unique card number corresponds to a valid, activated debit card issued by said institution; (2) whether the merchant's terminal ID information corresponds to a valid merchant listed as a participating merchant at the authorized shopping location; and (3) whether adequate funds are available to authorize the requested amount. If any of the above requirements are not met, the transaction would not usually be authorized, although the card issuing institution may in its discretion choose to authorize a transaction even if the adequate funds are not available and bill the customer later. If all of the above requirements are met, the transaction is authorized, the transaction is recorded in the central database, and the funds available for the unique card number is reduced accordingly. The card issuing institution then routes either the authorization or rejection back to the merchant through the authorization network. The central database may be operated by the card issuing institution or outsourced to a third party.

### BRIEF DESCRIPTION OF THE DRAWINGS

To facilitate further discussion of the invention, the following drawings are provided in which:

FIGS. 1 and 2 are views of a gift card for use in the present invention;

FIG. 3 is a diagrammatic view illustrating the computer process involved when adding value to the gift card of FIG. 1;

FIG. 4 is a diagrammatic view illustrating the computer process involved when using the gift card of FIG. 1 to make a transaction; and

FIG. 5 is a diagrammatic view illustrating the preferred sequence of steps to be followed when using the gift card of FIG. 1 to make a transaction.

These drawings are for illustrative purposes only and should not be used to unduly limit the scope of the claims.

### DETAILED DESCRIPTION OF THE INVENTION

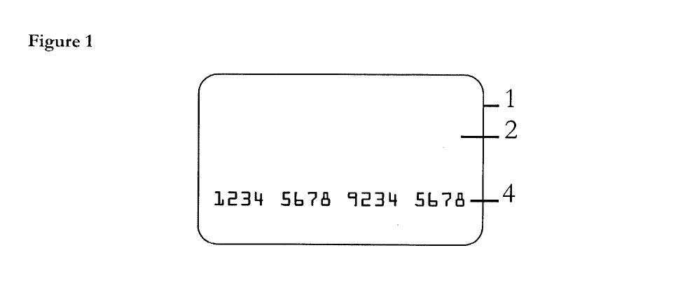

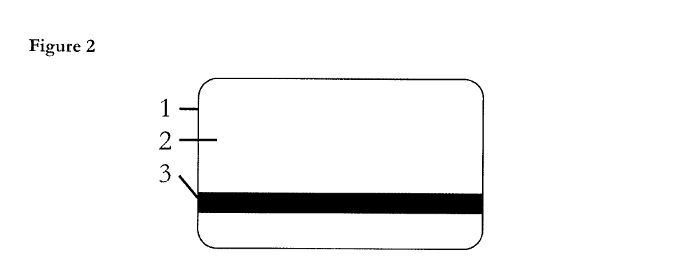

Referring first to FIGS. 1 and 2, a gift card 1 is illustrated. The gift card 1 comprises a card 2 and a magnetic stripe 3 for use in storing a card number 4.

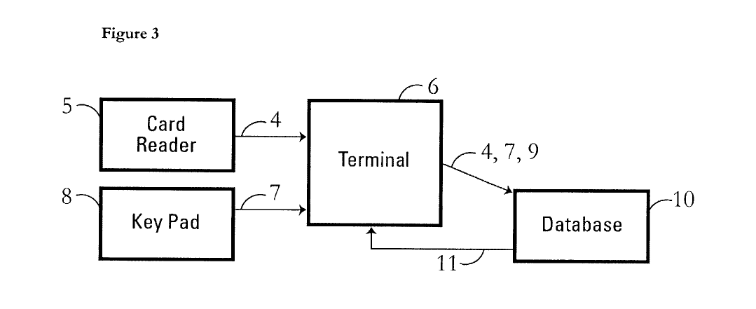

Referring now to FIG. 3, the gift card 1 is activated for use when purchased through the computer process shown. The unactivated gift card 1 is swiped through a card reader 5, which receives the card number 4 encoded by the magnetic stripe 3. The card reader 5 transfers this information to a terminal 6. In addition, a card dollar amount 7 is entered into a key pad 8, which transfers the card dollar amount 7 to the terminal 6. The card number 4, the dollar amount 7, and a unique shopping location identification number 9, which is associated with the terminal, are then transmitted to a central database 10 for recordation. Once the information is recorded, the database 10 transmits an authorization 11 to the terminal 6. The gift card 1 is then activated.

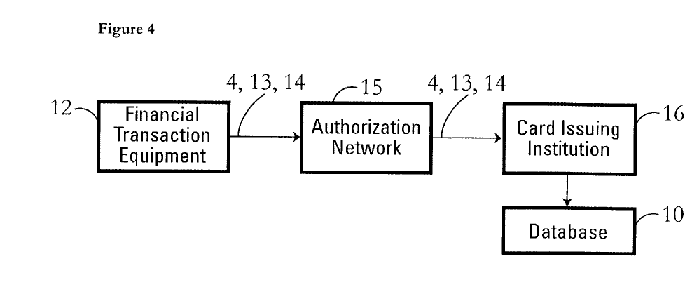

Referring now to FIG. 4, the activated gift card 1 can be used for purchase through the computer process shown. The merchant would swipe the gift card 1 through existing financial transaction equipment 12, such as their standard MasterCard/Visa credit/debit card authorization system, on which is stored a terminal merchant identification number 13. The merchant then enters the transaction dollar amount 14. The terminal identification number 13, the transaction dollar amount 14, and the card number 4 are then transferred through the MasterCard/Visa credit/debit card authorization network 15 to the card issuing institution authorization system 16, which authorizes or rejects the transaction through the central database 10. The merchant then receives a transaction authorization or rejection through the MasterCard/Visa credit/debt card authorization network 15 on its existing financial transaction equipment 12.

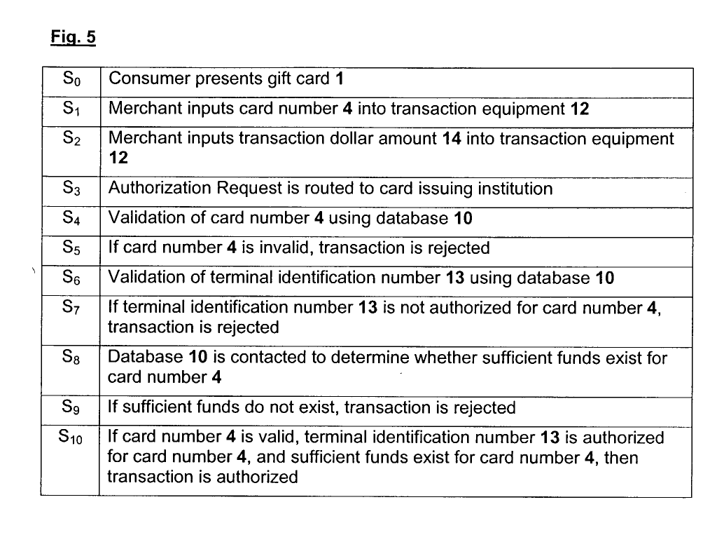

Referring now to FIG. 5, the transaction authorization or rejection takes place through the following steps. At step So, the consumer presents the gift card 1 as payment for a purchase. The merchant then inputs the card number 4 of the gift card 1 into the existing financial transaction equipment 12 through a method such as swiping the card, at step S₁. Next, the merchant inputs the transaction dollar amount 14 into the existing financial transaction equipment 12 at step S₂. At step S₃, the authorization request is routed through the authorization network 15, with the card number 4, the terminal identification number 13, and the transaction dollar amount 14, to the card issuing institution. Next, the card issuing institution authorization system 16 contacts the central database 10 to determine if the card number 4 is valid at step S₄. If it is not, the card issuing institution authorization system 16 rejects the transaction, and the merchant is notified through the authorization network 15 at step S₅. If the card number 4 is valid, then at step S₆ the card issuing institution authorization system 16 contacts the central database 10 to determine if the terminal identification number 13 corresponds to an authorized merchant at the shopping location at which the gift card 1 has been activated. If it does not, the card issuing institution authorization system 16 rejects the transaction, and the merchant is notified through the authorization network 15 at step S₇. If it does correspond, then at a step S₈ the card issuing institution authorization system 16 contacts the central database 10 to determine whether sufficient funds are available to the gift card 1. If the transaction dollar amount 14 is more than the card dollar amount 7, the card issuing institution authorization system 16 rejects the transaction, and the merchant is notified through the authorization network 15 at step S₉. If the transaction dollar amount 14 is equal to or less than the card dollar amount 7, the account balance is debited for the transaction dollar amount, the card issuing authorization system 16 authorizes the transaction, and the merchant is notified through the authorization network 15 at step S₁₀.

Although the present invention has been described in considerable detail with reference to certain preferred versions thereof, other versions are possible without departing from the spirit and scope of the present invention. Therefore the scope of the appended claims should not be limited to the description of the preferred embodiments described herein.

What is claimed is:

1. A method for authorizing a transaction, the method comprising the steps of:
(a) providing a debit card having an associated card ID information;
(b) providing a terminal having an associated terminal ID information;
(c) providing a computer database wherein said database comprises at least one authorized card ID information, each said authorized card ID information having an associated corresponding list of at least one authorized terminal ID information;
(c) retrieving via the terminal the card ID information associated with the debit card so as to provide a retrieved card ID information;
(d) transmitting to the database the retrieved card ID information and the associated terminal ID information;
(e) matching via the database the retrieved card ID information with the authorized card ID information;
(f) matching via the database the associated terminal ID information with an authorized terminal ID information contained in the corresponding list associated with the authorized card ID information; and
(g) transmitting a validation to the terminal.

2. The method of claim 1 wherein each authorized terminal ID information corresponds to an authorized specific merchant.

3. The method of claim 2 wherein all authorized specific merchants associated with an authorized card ID information are located at a single shopping location.

4. The method of claim 3 wherein the single shopping location is selected from a group consisting of a single merchant, a shopping mall, and a shopping district.

5. The method of claim 4 wherein the single shopping location is selected from a group consisting of a municipality, a town, a city, a county, and a state.

6. A method for authorizing a transaction, the method comprising the steps of:
(a) providing a debit card having an associated card ID information;
(b) providing a terminal having an associated terminal ID information;
(c) providing a computer database wherein said database comprises at least one authorized card ID information, each said authorized card ID information having an associated authorized dollar amount and an associated corresponding list of at least one authorized terminal ID information;
(c) retrieving via the terminal the card ID information stored on the debit card so as to provide a retrieved card ID information;
(d) entering into the terminal a transaction dollar amount;
(e) transmitting to the database the retrieved card ID information, the associated terminal ID information, and the transaction dollar amount;
(f) matching via the database the retrieved card ID information with the authorized card ID information;
(g) matching via the database the terminal ID information with an authorized terminal ID information contained in the corresponding list associated with the authorized card ID information;
(h) comparing the transaction dollar amount with the authorized dollar amount associated with the authorized card ID information to ensure that the authorized dollar amount is equal to or greater than the transaction dollar amount;
(i) transmitting via the computer a validation to the terminal.

7. The method of claim 6 wherein each authorized terminal ID information corresponds to an authorized specific merchant.

8. The method of claim 7 wherein the specific merchants associated with an authorized card ID information all authorized are located at a single shopping location.

9. The method of claim 8 wherein the single shopping location is selected from a group consisting of a single merchant, a shopping mall, and a shopping district.

10. The method of claim 8 wherein the single shopping location is selected from a group consisting of a municipality, a town, a city, a county, and a state.

11. A transaction authorization system, consisting of a computer database wherein said database consists of at least one authorized card ID information, each said authorized card ID information having an associated corresponding list of at least one authorized terminal ID information.

12. The system of claim 11 wherein each authorized terminal ID information corresponds to an authorized specific merchant.

13. The method of claim 12 wherein the specific merchants associated with an authorized card ID information all authorized are located at a single shopping location.

14. The method of claim 13 wherein the single shopping location is selected from a group consisting of a single merchant, a shopping mall, and a shopping district.

15. The method of claim 13 wherein the single shopping location is selected from a group consisting of a municipality, a town, a city, a county, and a state.

16. A transaction authorization system, consisting of a computer database wherein said database comprises at least one authorized card ID information, each said authorized card ID information having an associated authorized dollar amount and an associated corresponding list of at least one authorized terminal ID information.

17. The system of claim 16 wherein each authorized terminal ID information corresponds to an authorized specific merchant.

18. The method of claim 17 wherein the specific merchants associated with an authorized card ID information all authorized are located at a single shopping location.

19. The method of claim 18 wherein the single shopping location is selected from a group consisting of a single merchant, a shopping mall, and a shopping district.

20. The method of claim 18 wherein the single shopping location is selected from a group consisting of a municipality, a town, a city, a county, and a state.
